(19) United States
(12) Patent Application Publication
(10) Pub. No.: US 2006/0114791 A1
(43) Pub. Date: Jun. 1, 2006

(54) Ultra-high data density optical media system

(76) Inventors: Charles Marshall, Burbank, CA (US); John A. Trepl II, Dana Point, CA (US); Roger A. Kuntz, Laguna Niguel, CA (US); Axel M. Kuntz, Lake Forest, CA (US); Vladimir Tchoutko, Irvine, CA (US)

Correspondence Address: CHARLES MARSHALL, 211 NORTH MYERS STREET, #A, BURBANK, CA, 91506, US

(21) Appl. No.: 11/001,236

(22) Filed: Nov. 30, 2004

(51) Int. Cl. G11B 7/00

(52) U.S. Cl. 369/100

(57) ABSTRACT

A system and corresponding method for reading an optical medium by reading different wavelengths of light as it reflects off of the medium. The system includes a light source for emitting light at an optical medium having features representing data, the features on the optical medium causing variations in the way the light is reflected. An optical filter separates the light reflected from the optical medium into multiple wavelengths. One or more sensors detect changes in the light in the different wavelengths, the changes representing data.

### FIELD OF THE INVENTION

The present invention relates to optical media systems and more particularly, this invention relates to an optical media system using multiple-wavelength light detection for dramatically improved data density capabilities.

### BACKGROUND OF THE INVENTION

Optical media presently include compact discs (CDs), digital video discs (DVDs), laser discs, and specialty items. Optical media has found great success as a medium for storing music, video and data due to its durability, long life, and low cost.

A CD typically comprises an underlayer of clear polycarbonate plastic. During manufacturing, the polycarbonate is injection molded against a master having protrusions (or pits) in a defined pattern that creates an impression of microscopic bumps arranged as a single, continuous, spiral track of data on the polycarbonate. Then, a thin, reflective aluminum layer is sputtered onto the disc, covering the bumps. Next a thin acrylic layer is sprayed over the aluminum to protect it. A label is then printed onto the acrylic. FIG. 1 illustrates a cross section of a typical data or audio CD 100, particularly depicting the polycarbonate layer 102, aluminum layer 104, acrylic layer 106, label 108, and pits 110 and lands 112 that represent the data stored on the CD 100. Note that the “pits” 110 are as viewed from the aluminum side, but on the side the laser reads from, they are bumps. The elongated bumps that make up the data track are each 0.5 microns wide, a minimum of 0.83 microns long and 125 nanometers high. The dimensions of a standard CD is about 1.2 millimeters thick and about 4.5 inches in diameter. A CD can hold about 740 MB of data.

During playback, the reader's laser beam passes through the polycarbonate layer, reflects off the aluminum layer and hits an opto-electronic device that detects changes in light. The steps between the bumps reflect light differently than the lands, and an opto-electronic sensor detects that change in reflectivity. The electronics in the reader interpret the changes in reflectivity in order to read the bits that make up the data.

A DVD is very similar to a CD, and is created and read in generally the same way (save for multilayer DVDs, as described below). However, a single-sided, single-layer DVDs can store about seven times more data than CDs. A large part of this increase comes from the pits and tracks being smaller on DVDs. Table 1 illustrates a comparison of CD and DVD specifications.

TABLE 1

| Specification | CD | DVD |
|---|---|---|
| Track Pitch | 1600 nanometers | 740 nanometers |
| Minimum Pit Length | 830 nanometers | 400 nanometers |
| (single-layer DVD) | | |
| Minimum Pit Length | 830 nanometers | 440 nanometers |
| (double-layer DVD) | | |

To increase the storage capacity even more, a DVD can have multiple layers, several layers being readable on each side. The laser that reads the disc can actually focus on the inner layers through the outer layers. Table 2 lists the capacities of several typical forms of DVDs.

TABLE 2

| Format | Capacity | Approx. Movie Time | |
|---|---|---|---|
| Single-sided/single-layer | 4.38 GB | 2 | hours |
| Single-sided/double-layer | 7.95 GB | 4 | hours |
| Double-sided/single-layer | 8.75 GB | 4.5 | hours |
| Double-sided/double-layer | 15.9 GB | Over 8 | hours |
| Single-sided/single-layer (Blu-ray) | 27 GB | 13 | hours |

A DVD is composed of several layers of plastic, totaling about 1.2 millimeters thick. FIG. 2 depicts the cross section of a single sided/double-layer DVD 200. Each layer is created by injection molding polycarbonate plastic against a master, as described above. This process forms a disc 200 that has microscopic bumps arranged as a single, continuous and extremely long spiral track of data. Once the clear pieces of polycarbonate 202, 204 are formed, a thin reflective layer is sputtered onto the disc, covering the bumps. Aluminum 206 is used behind the inner layers, but a semi-reflective gold layer 208 is used for the outer layers, allowing the laser to focus through the outer and onto the inner layers. After all of the layers are made, each one is coated with lacquer, squeezed together and cured under infrared light. For single-sided discs, the label is silk-screened onto the nonreadable side. Double-sided discs are printed only on the nonreadable area near the hole in the middle.

An emerging technology known as Blu-ray uses blue-violet laser light to achieve data storage capacities of up to 27 GB. The Blu-ray Disc enables the recording, rewriting and play back of up to 27 gigabytes (GB) of data on a single sided single layer 12 cm CD/DVD size disc using a 405 nm blue-violet laser. The companies that established the basic specifications for the Blu-ray Disc are: Hitachi Ltd., LG Electronics Inc., Matsushita Electric Industrial Co., Ltd., Pioneer Corporation, Royal Philips Electronics, Samsung Electronics Co. Ltd., Sharp Corporation, Sony Corporation, and Thomson Multimedia.

A DVD player functions similarly to the CD player described above. However, in a DVD player, the laser can focus either on the semi-transparent reflective material behind the closest layer, or, in the case of a double-layer disc, through this layer and onto the reflective material behind the inner layer. The laser beam passes through the polycarbonate layer, bounces off the reflective layer behind it and hits an opto-electronic device, which detects changes in light.

One problem with optical media is that current read technology only allows reading of a single laser wavelength. The result is that the data density of current optical media is limited. What is therefore needed is a way to increase the data density of optical media, and the ability to read the increased data density.

### SUMMARY OF THE INVENTION

Accordingly, the present invention provides a system and corresponding method for reading an optical medium by reading different wavelengths of light as it reflects off of the medium. The system includes a light source for emitting light at an optical medium having features representing data, the features on the optical medium causing variations in the way the light is reflected. An optical filter separates the light reflected from the optical medium into multiple wavelengths. One or more sensors (e.g., photo diodes) detect changes in the light in the different wavelengths, the changes representing data.

In one embodiment, the optical filter and sensor(s) are present on a single substrate. The reflected light can enter the filter directly or via a medium such as a fiber optic cable.

The filter acts as a demultiplexer to separate the light into at least two different wavelengths, and can separate the light into many different wavelengths, e.g., 2, 3, 4, 5, 6, 8 or more. Multiple sensors can simultaneously detect changes in the light in the different wavelengths, thereby providing at least a 2× or more improvement over standard optical media systems.

In one embodiment, the surface features on the optical medium are positioned on the same layer of material of the optical medium, the surface features having differing dimensions for reflecting the light differently for each wavelength. In another embodiment, the surface features on the optical medium are positioned on different layers of material of the optical medium, the surface features having differing dimensions for reflecting the light differently for each wavelength.

A circuit is coupled to the at least one sensor. The circuit interprets signals created by the sensor(s) for converting the signal into digital data. The circuit can also be formed on the same substrate as the optical filter and sensors.

The optical medium can have physical dimensions substantially the same as a standard CD or DVD, mini-CD, etc. Preferably, the system can also read data from standard CDs and DVDs for backward compatibility.

Another embodiment is capable of reading transmissive media. A system for reading a transmissive optical medium includes a light source for emitting light at an optical medium having features representing data, the light passing through the optical medium, the features on the optical medium causing variations in the way the light passes through the optical medium. An optical filter separates the light passing through the optical medium into multiple wavelengths. One or more sensors detect changes in the light in the different wavelengths, the changes representing the data.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a partial cross sectional view, not to scale, of a CD.

FIG. 2 is a partial cross sectional view, not to scale, of a single sided, dual-layer DVD.

FIG. 3A is a simplified system view of a system for reading a reflective optical medium.

FIG. 3B is a simplified system view of a system for reading a transmissive optical medium.

FIG. 4A is a view of an optical filter.

FIG. 4B is a partial view of a variation of the optical filter of FIG. 4A.

FIG. 5 is a diagram of a second embodiment of the thin film filter with a second plurality of optical structures disposed on different regions of a second common substrate according to the present invention;

FIG. 6 is a diagram of a third embodiment of the thin film filter having opposing glass substrates with a filled or void space in between according to the present invention.

FIG. 7 illustrates an optical receiver formed in an integrated package according to the present invention.

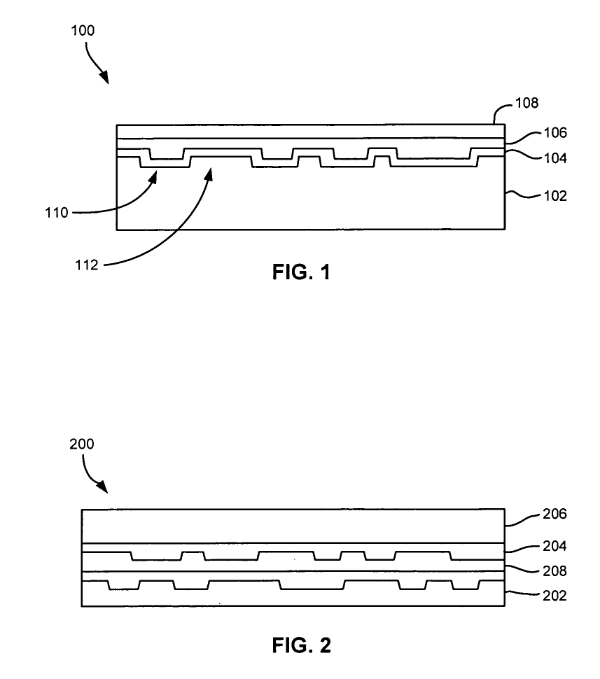

### BEST MODE FOR CARRYING OUT THE INVENTION

The following description is the best embodiment presently contemplated for carrying out the present invention. This description is made for the purpose of illustrating the general principles of the present invention and is not meant to limit the inventive concepts claimed herein.

The present invention is directed to use of an optical demultiplexer and a method for separating an input optical signal into a plurality of channels by wavelength for reading data from optical media.

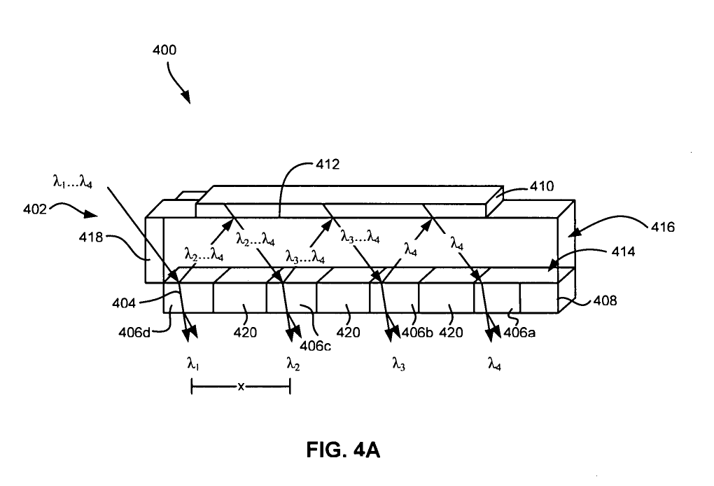

FIG. 3A illustrates a system 300 for reading an optical medium 302 by reading different wavelengths of light as it reflects off of the medium. The system 300 includes a light source 304 for emitting light at a rotating optical medium 302 having features representing data, the features on the optical medium causing variations in the way the light is reflected. The light source can be a tunable laser capable of emitting light in various wavelengths. The system is also UV capable.

An optical filter (not shown) separates the light reflected from the optical medium into multiple wavelengths. One or more sensors (e.g., photo diodes, not shown) detect changes in the light in the different wavelengths, and outputs signals representing data based on the changes. During playback, the system 300 functions in generally the same way as a standard CD or DVD reader, moving the light source 304, filter and sensors along the medium to follow the data track(s) thereon.

In a preferred embodiment, the optical filter and sensor(s) are present on a single substrate 306, and can be formed as a single chip. The reflected light can enter the filter directly or via a medium such as a fiber optic cable. The substrate, filter and sensors are described in more detail below, but will be described briefly to provide context.

In brief, the filter acts as a demultiplexer to separate the light into at least two different wavelengths, and can separate the light into many different wavelengths, e.g., 2, 3, 4, 5, 6, 7, 8 or more. Multiple sensors can simultaneously detect changes in the light in the different wavelengths, thereby providing at least a 2× or more improvement in data density over standard optical media systems.

A circuit 308 is coupled to the at least one sensor. The circuit interprets signals created by the sensor(s) for converting the signal into digital data, much in the same way as a standard DVD player interprets data signals during playback. The circuit can also be formed on the same substrate or chip as the optical filter and sensors.

The optical medium itself is much like the CDs and DVDs described above. However, the surface features on the optical medium have differing properties and/or dimensions for instance for reflecting the light differently for each wavelength. For example, one set of features can be set with dimensions for a first wavelength and another set of features can be set with dimensions for a second wavelength. The characteristics of the reflected light will vary based on these features, the variations being readable by detecting changes at particular wavelengths in the reflected light. When reading the features set to the first wavelength, the system will recognize a coherent data stream coming from the sensor for that wavelength, and variations in the other wavelengths at that particular sensor will either be blocked by optical filtration, or will be recognized and filtered out by the system. The other sensors will likewise provide a stream of data for the other wavelengths.

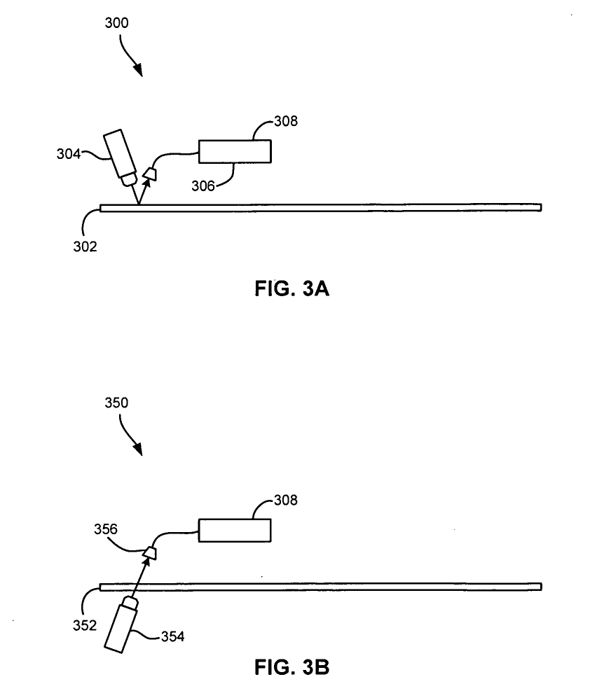

The surface features can be positioned on the same layer of material of the optical medium, and aligned in vertical layers and/or in horizontal spirals. The surface features can also be positioned on different layers of material of the optical medium but along the same data track, much in the same way multi-layer DVDs are created. Note FIG. 2 and related discussion. U.S. Pat. No. 5,526,338 to Hasman et al. discloses a system for reading multilayer discs, and is incorporated herein by reference for all purposes. The present invention improves upon Hasman but can use some of the same technology.

The optical medium can have physical dimensions substantially the same as a standard CD or DVD, mini-CD, etc. Preferably, the system can also read data from standard CDs and DVDs for backward compatibility.

Another embodiment is capable of reading transmissive media. This embodiment is shown in FIG. 3B. A system 350 for reading a transmissive optical medium 352 includes a light source 354 for emitting light at an optical medium 352 having features representing data, the light passing through the optical medium 352, the features on the optical medium 352 causing variations in the way the light passes through the optical medium 352. An optical filter 356 separates the light passing through the optical medium 352 into multiple wavelengths. One or more sensors (not shown) of the optical filter 356 detect changes in the light in the different wavelengths, the changes representing the data.

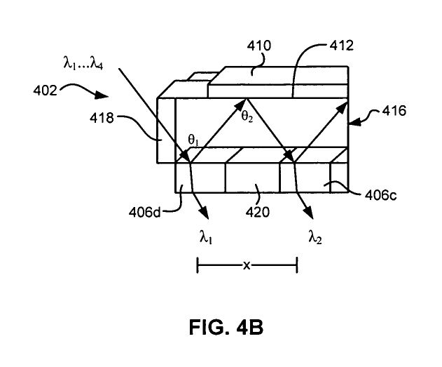

In FIG. 4 there is illustrated a multi-channel optical filter 400. Filter 400 functions as an optical demultiplexer and separates an input optical signal 402 into a plurality of channels 404 by wavelength. The filter 400 comprises a first plurality of optical structures 406 that have been formed using vapor deposition on different regions of a first common substrate 408 using the methods described above. For purposes of clarity, the optical structures 406 are illustrated in FIG. 4 as being arranged in a discontinuous pattern, with an inter-channel transition structure 420 positioned between each adjacent pair of optical structures. As discussed in more detail below, the inter channel transition structure may be comprised of the same material used to form the filters, air, or a light blocking material or mask. The light blocking mask prevents light from passing between adjacent optical structures 406a, 406b, 406c, 406d. Regardless of the transition structure, in one embodiment the spacing between the center of adjacent optical structures 406 is described by the equation:
2(T)/tan θ
where T=the transport region thickness, and θ=incident angle of light with respect to a plane of the substrate. This assumes parallelism between the reflector 410 and the optical structures 406a, 406b, 406c, 406d.

FIG. 4B illustrates another embodiment where the reflector 410 and the optical structures 406c, 406d have a different refractive index. For materials with different refractive indices, the following equation is used:
T(tan θ₁)+T(tan θ₂)

Each optical structure 406 in the first plurality is composed of a plurality of thinfilm layers. The thickness of each layer in any given optical structure 406 in the first plurality of structures is associated with the wavelength of one of the optical signal channels 404.

The optical filter 400 further comprises a reflector 410 having a surface 412 parallel to a surface 414 of the first common substrate 408. A transport region 416 separates the reflector 410 from the first plurality of the optical structures 406. The transport region 416 may be glass or any other transport media having the property of transparency, flatness and rigidity which are commonly known to those skilled in the art. Note that the parallelism of the surfaces can be varied in practice to accomplish the spacing of the transport region 416.

An aperture 418 is disposed at one end of the transport region 416. Such aperture may comprise a combination of lenses, prisms (e.g., to provide input beam deflection) or other optical elements. When the input optical signal 402 is provided to the aperture 418, output optical signals at different wavelengths (i.e. λ₁, λ₂, λ₃, λ₄,) associated with different ones of the channels are generated at separate positions along a length of the transport region 416. The action is known as demultiplexing. In one embodiment each of the first plurality of optical structures 406 on the first common substrate 408 corresponds to a different one of the channels 404, and transmits light at a wavelength corresponding to that channel but reflects light at all of the other wavelengths corresponding to channels 404.

In one embodiment of the present invention, the reflector 410 of the optical filter 400 is a specular reflector. Where the reflector 410 is a specular reflector, it may be a metal specular reflector or a dielectric mirror.

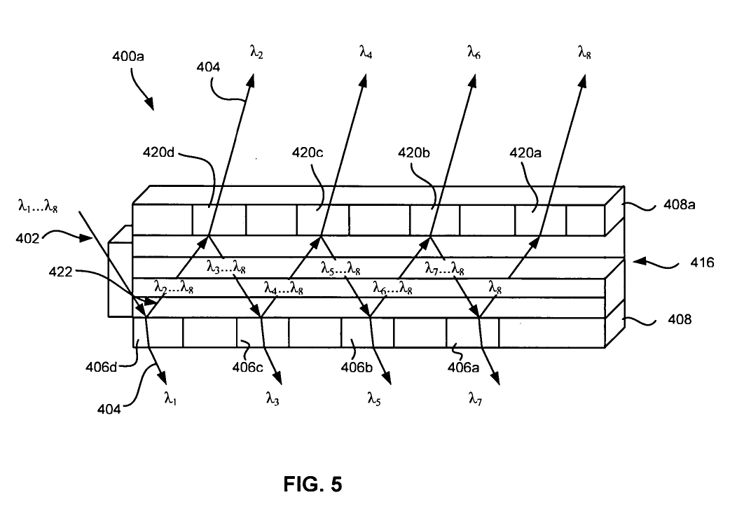

In FIG. 5, there is shown still another embodiment of the invention. Optical filter 400a is comprised of a second plurality of optical structures 420 disposed on different regions of a second common substrate 408a. The second common substrate 408a is aligned in parallel with the first common substrate 408. Each optical structure 420 in the second plurality is composed of a plurality of thin-film layers, and is formed simultaneously using vapor deposition on different regions of substrate 408a using the methods described above. The thickness of each layer in a given optical structure 420 in the second plurality is associated with one of the channels 404. The initial optical signal 402 of this embodiment is first incident upon one of the first plurality of optical structures 406 which filters a single channel and reflects the remaining signal channels. The reflected signal 422 is then incident upon one of the second plurality of optical structures 420 which filters another single channel and reflects the remaining optical signal channels. The reflected optical signal 422 thereafter progresses through the transport region alternating between one of the first plurality of optical structures 406 and one of the second plurality of optical structures 420. With each contact with an optical structure 406,420 a single channel is filtered from the reflected signal 422.

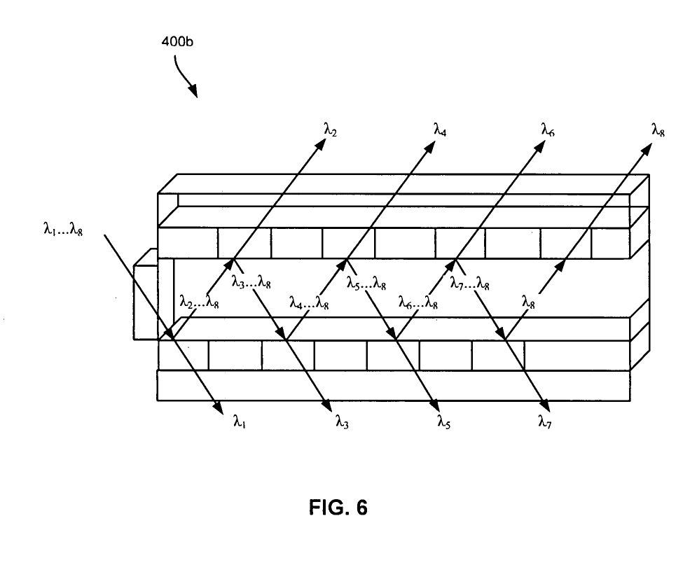

In the embodiment shown in FIG. 5, the transport region 416 between the first and second plurality of optical structures 406,420 is glass. In another embodiment shown in FIG. 6, the transport region 416 is air, but would function substantially the same with a gas, fluid, or vacuum therebetween.

The invention also includes a method of separating an input optical signal 402 into a plurality of channels by wavelength using, for example, a multi-channel optical filter such as filter 400, 400a, or 400b. Devices performing this function are commonly called demultiplexers. The method comprises the step of providing a first plurality of simultaneously deposited optical structures 406. The optical structures 406 are disposed on different regions of a first common substrate 408. Each optical structure 406 in the first plurality is composed of a plurality of thin-film layers. In this method, the thickness of each layer in a given optical structure 406 in the first plurality is associated with one of the channels. A reflector having a surface parallel to a surface of the first common substrate 408 is also provided. The optical filter has a transport region 416 between the first plurality of the optical structures 406 and the reflector 410, and an aperture 418 disposed at one end of the transport region. When the input optical signal is provided to the aperture, output optical signals are generated at separate positions along a length of the transport region, each of the output optical signals being associated with a different one of the channels.

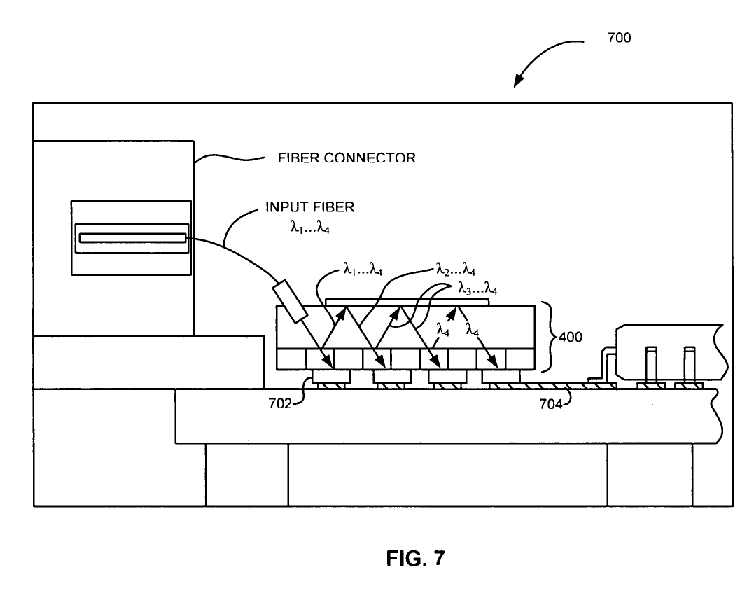

Referring now to FIG. 7, there is shown a diagram illustrating an optical receiver formed in a single integrated package, according to the present invention. Optical receiver 700 includes an array of photo diodes 702 which have been surface mounted to board 704. An optical filter 400 is then affixed immediately above the photo diodes 702. The array of photo diodes 702 and optical filter 400 may be combined into a single integrated optical package, that can then be surface mounted on circuit board 704. During operation of the receiver circuit 308, an input optical fiber carries a multiplexed optical signal representing a combination of optical signals at different wavelengths. The multiplexed optical signal is provided to the transport region of filter 400, where it is sequentially applied to each of the optical structures 406. As shown in FIG. 7, each of the optical structures 406 in filter 400 is tuned to pass a particular wavelength of light. Optical signals (each of which corresponds to a particular wavelength) then pass out of filter 400 and are provided to the photo diodes 702. Each photo diode 702 converts one of the optical signals output from filter 400 into a corresponding electrical signal. In this embodiment, lenses may be placed between photo diodes 702 and optical filter 400 to improve device performance.

Other embodiments of integrated receivers may stack and bond separate substrates containing optical filters 400 and arrays of photo diodes 702. In these embodiments, multiple device units might be stacked and bonded and then diced from the resulting structure to yield individual devices. The purpose of such assemblies and techniques is to reduce size and cost, improve alignment of the separate optical structures, and improve performance of the resulting assemblies. These assemblies may then be packaged or mounted directly on an optical circuit board to function with other optical and electrical elements.

The methodology for forming the filter is described in PCT Patent Application No. WO 02/075996 to Baldwin et al., which is herein incorporated by reference for all purposes.

One preferred single chip device having a filter and sensors is the MUX/DEMUX MULTI-FILTER CHIP available from 4Wave, Inc., 22977 Eaglewood Court, Suite 120, Sterling, Va. 20166, USA.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A system for reading an optical medium, comprising:
a light source for emitting light at an optical medium having features representing data, the light being reflected by the optical medium, the features on the optical medium causing variations in the way the light is reflected;
an optical filter for separating the light reflected from the optical medium into multiple wavelengths; and
at least one sensor for detecting changes in the light in the different wavelengths, the changes representing data, wherein the optical filter and at least one sensor are present on a single substrate.

2. The system as recited in claim 1, wherein the optical filter comprises:
a first plurality of optical structures formed simultaneously on different regions of a first common substrate using vapor deposition, each optical structure in the first plurality being composed of a plurality of thin-film layers, the thickness of each layer in a given optical structure in the first plurality being associated with one of the channels;
a reflector having a surface parallel to a surface of the first common substrate;
the optical filter having a transport region between the first plurality of the optical structures and the reflector, and an aperture disposed at least one end of the transport region, wherein the first plurality of optical structures are disposed along a length of the transport region; and
wherein, when the input optical signal is provided to the aperture, output optical signals associated with different ones of the channels are generated at separate positions along the length of the transport region.

3. The system as recited in claim 1, wherein the reflected light enters the filter directly.

4. The system as recited in claim 1, wherein a fiber optic cable carries the reflected light to the filter.

5. The system as recited in claim 1, wherein the light is separated into at least two different wavelengths.

6. The system as recited in claim 1, wherein the light is separated into at least four different wavelengths.

7. The system as recited in claim 1, wherein the light is separated into at least six different wavelengths.

8. The system as recited in claim 1, wherein the light is separated into at least eight different wavelengths.

9. The system as recited in claim 1, wherein multiple sensors are present, the sensors simultaneously detecting changes in the light in the different wavelengths.

10. The system as recited in claim 1, wherein the surface features on the optical medium are positioned on the same layer of material of the optical medium, the surface features having differing dimensions for reflecting the light differently for each wavelength.

11. The system as recited in claim 1, wherein the surface features on the optical medium are positioned on different layers of material of the optical medium, the surface features having differing dimensions for reflecting the light differently for each wavelength.

12. The system as recited in claim 1, further comprising a circuit coupled to the at least one sensor, the circuit interpreting signals created by the at least one sensor for converting the signal into digital data.

13. The system as recited in claim 11, wherein the light is separated and detected on a single filter, wherein the circuit is formed on the same substrate.

14. The system as recited in claim 1, wherein the optical medium has physical dimensions substantially the same as a standard compact disc (CD).

15. The system as recited in claim 1, wherein the system can also read data from a standard compact disc (CD).

16. The system as recited in claim 1, wherein the system can also read data from a standard digital video disc (DVD).

17. A system for reading an optical medium, comprising:
a light source for emitting light at an optical medium having features representing data, the light being reflected by the optical medium, the features on the optical medium causing variations in the way the light is reflected;
an optical filter for separating the light reflected from the optical medium into multiple wavelengths; and
multiple sensors for detecting changes in the light in the different wavelengths, the changes representing data;
wherein the optical filter and sensors are present on a single substrate.

18. The system as recited in claim 17, wherein the optical filter comprises
a first plurality of optical structures formed simultaneously on different regions of a first common substrate using vapor deposition, each optical structure in the first plurality being composed of a plurality of thin-film layers, the thickness of each layer in a given optical structure in the first plurality being associated with one of the channels;
a reflector having a surface parallel to a surface of the first common substrate;
the optical filter having a transport region between the first plurality of the optical structures and the reflector, and an aperture disposed at least one end of the transport region, wherein the first plurality of optical structures are disposed along a length of the transport region; and
wherein, when the input optical signal is provided to the aperture, output optical signals associated with different ones of the channels are generated at separate positions along the length of the transport region.

19. The system as recited in claim 17, wherein the reflected light enters the filter directly.

20. The system as recited in claim 17, wherein a fiber optic cable carries the reflected light to the filter.

21. The system as recited in claim 17, wherein the light is separated into at least two different wavelengths.

22. The system as recited in claim 17, wherein the light is separated into at least four different wavelengths.

23. The system as recited in claim 17, wherein the light is separated into at least six different wavelengths.

24. The system as recited in claim 17, wherein the light is separated into at least eight different wavelengths.

25. The system as recited in claim 17, wherein the sensors simultaneously detect changes in the light in the different wavelengths.

26. The system as recited in claim 17, wherein the surface features on the optical medium are positioned on the same layer of material of the optical medium, the surface features having differing dimensions for reflecting the light differently for each wavelength.

27. The system as recited in claim 17, wherein the surface features on the optical medium are positioned on different layers of material of the optical medium, the surface features having differing dimensions for reflecting the light differently for each wavelength.

28. The system as recited in claim 17, further comprising a circuit coupled to the sensors, the circuit interpreting signals created by the at least one sensor for converting the signal into digital data.

29. The system as recited in claim 28, wherein the light is separated and detected on a single chip, wherein the circuit is formed on the same chip.

30. The system as recited in claim 17, wherein the optical medium has physical dimensions substantially the same as a standard compact disc (CD).

31. The system as recited in claim 17, wherein the system can also read data from a standard compact disc (CD).

32. The system as recited in claim 17, wherein the system can also read data from a standard digital video disc (DVD).

33. A method for reading an optical medium, comprising:
emitting light at an optical medium having features representing data, the light being reflected by the optical medium, the features on the optical medium causing variations in the way the light is reflected;
separating the light reflected from the optical medium into multiple wavelengths using an optical filter; and
detecting changes in the light in the different wavelengths using sensors, the changes representing the data;
wherein the optical filter and sensors are present on a single substrate.

34. A system for reading a transmissive optical medium, comprising:
a light source for emitting light at an optical medium having features representing data, the light passing through the optical medium, the features on the optical medium causing variations in the way the light passes through the optical medium;
an optical filter for separating the light passing through the optical medium into multiple wavelengths; and
at least one sensor for detecting changes in the light in the different wavelengths, the changes representing the data.

35. A system for reading an optical medium, comprising:
a light source for emitting light at an optical medium having features representing data arranged in at least one data track, the light being reflected by the optical medium, the features on the optical medium causing selective reflection of various wavelengths of the light;
an optical filter for separating the light reflected from the optical medium into multiple wavelengths; and
at least one sensor for detecting the presence or absence of light in the different wavelengths, the presence or absence of light representing data.

36. A system for reading an optical medium, comprising:
a light source for emitting light at an optical medium having features representing data thereon, the light being reflected by the optical medium, the features on the optical medium causing selective reflection of various wavelengths of the light;
an optical filter for separating the light reflected from the optical medium into multiple wavelengths; and
at least one sensor for detecting the presence or absence of light in the different wavelengths, the presence or absence of light representing data,
wherein the optical filter comprises
a first plurality of optical structures formed simultaneously on different regions of a first common substrate using vapor deposition, each optical structure in the first plurality being composed of a plurality of thin-film layers, the thickness of each layer in a given optical structure in the first plurality being associated with one of the channels;
a reflector having a surface parallel to a surface of the first common substrate;
the optical filter having a transport region between the first plurality of the optical structures and the reflector, and an aperture disposed at least one end of the transport region, wherein the first plurality of optical structures are disposed along a length of the transport region; and
wherein, when the input optical signal is provided to the aperture, output optical signals associated with different ones of the channels are generated at separate positions along the length of the transport region.
